(19) United States
(12) Patent Application Publication
(10) Pub. No.: US 2005/0059475 A1
(43) Pub. Date: Mar. 17, 2005

(54) Gaming device and method with bonus feature requiring an on-screen symbol and off-screen qualification

(76) Inventors: Tony Breen, Las Vegas, NV (US); Jason Poole, Las Vegas, NV (US)

Correspondence Address: Anderson & Morishita, L.L.C., Suite 102, 2725 S. Jones Blvd., Las Vegas, NV, 89146, US

(21) Appl. No.: 10/663,927

(22) Filed: Sep. 16, 2003

(51) Int. Cl. A63F 13/00

(52) U.S. Cl. 463/20

(57) ABSTRACT

A gaming device and method are set forth which includes a bonus which is triggered by the random selection and display of a designated bonus trigger symbol, the selection and display of the bonus trigger symbol in a selected location in the display matrix and the random selection of a bonus “On” condition. By adjusting the frequencies of the distribution of bonus trigger symbols, selection of a location and selection of the bonus “On” condition.

### FIELD OF THE INVENTION

The present invention relates to gaming devices and methods which provide for a bonus game. More particularly it relates to such devices and methods which include an on-screen trigger symbol and at least one randomly selected, off-screen, bonus qualification parameter.

### BACKGROUND

Electro-mechanical slot machines are well known. Mechanical reels include symbols on their reel strips and are driven by stepper motors to rotate and stop presenting symbol combinations on one or more pay lines. Depending upon the pay line(s) symbol combinations, the player has one or more winning combinations or losing combinations. For winning combinations, the player receives an award based upon an established pay schedule. (referred to as the “pay table”).

Modernly it has been known to provide a secondary, bonus screen for electro-mechanical slot machines, embodied, for example, as a plasma screen disposed apart from the game display. Based upon a triggering event, the bonus screen selects a bonus for the player.

In addition to the electro-mechanical slot machines, video slot machines are well known and are quite popular with players. In a basic form, the player makes a wager to play the game and enables one or more pay lines on a video display. Upon prompting play, a processor selects and displays game symbols on the display in a matrix form. The symbols on any enabled pay line are compared to the established pay table of winning outcomes to determine if a winning or a losing outcome have been obtained. Where a winning outcome is obtained the player receives an award based upon an established pay table for the game. The player then makes another wager, enables one or more pay lines and plays another game (often referred to as a “hand” or “spin”).

To make such video games more entertaining, it is known to provide certain configurations of bonuses. The bonus may be triggered by a certain combination of symbols on a pay line or scattered on the display (a “scatter prize”) during the play of the base game. It is also known to provide secondary screens for issuing a bonus triggered by predetermined symbol combinations obtained on a spin. These secondary, bonus screens may be embodied as a display separate from the primary, or base, game display or a common display may be used where, when the bonus is triggered, the base game display is controlled to display the bonus feature display(s). That is, when the player obtains a certain, predetermined, outcome during play of the base game, the game processor displays a bonus screen where the player can select from certain options to obtain their bonus. For example, in one game, the player selects by a touch screen from between several displayed. “pigs”, the selected pig, in an animated fashion, revealing the bonus. The bonus can be a fixed amount, usually a function of the amount wagered, or a multiplier which multiplies the amount won.

A drawback of these games is that the player knows immediately, from the symbol combination obtained on a spin, whether there is a bonus outcome. Thus, there is no element of surprise to the player as to whether or not the bonus triggering outcome has been obtained.

Still further, the distribution of symbols required to provide frequent secondary bonuses, requires that the bonuses be low whereas to achieve higher bonus awards, the distribution must provide for infrequent selection and display of the bonus trigger symbols. The infrequent display of the triggering symbols can frustrate the player. Still further the relationship of symbol selection frequency provides little leeway for a game designer to select and configure the bonuses features, including their frequency and amount the award.

Further there is a need for a game device and method which provides an entertaining bonus feature configured to stimulate interest in the game and entertain not only the player but bystanders, inducing all to play the game.

### SUMMARY OF THE INVENTION

There is, therefore, set forth according to the present invention a game device and method which provides an entertaining and exciting bonus feature and which provides for configuring bonus triggering frequency apart from symbol selection and display frequency

A gaming device and method are set forth which includes a game display such as an electronic video display, to display a plurality of reels each presenting a plurality of symbols to produce an outcome. As but an example, where the game is a video game, a processor is provided to randomly select symbols and to control the display to simulate rotation of the reels for presenting the selected symbols in a matrix. For example, for a five reel device, the matrix may be a 3×5 matrix. A bonus trigger is associated with at least one of said symbols. A processor is configured to select a matrix location parameter and to issue a bonus upon the concurrence of (i) a bonus trigger outcome and (ii) a bonus trigger associated symbol is positioned in association with the selected matrix location parameter. For example, the processor may select at least one of a row, a column or a matrix coordinate such that if the bonus trigger associated symbol (or symbols) is selected and displayed in the selected row, column or coordinate, the bonus feature is triggered.

Further, the device of the present invention may include the processor configured to randomly select between a bonus and non-bonus condition parameter and to issue a bonus award upon the concurrence of (1) selection of a bonus condition parameter and (2) the selection and display of the bonus trigger associated symbol (or symbols) in the selected row, column or coordinate.

The matrix location parameter and bonus versus non-bonus parameters may be selected with each spin or game.

It can be appreciated that by varying the bonus symbol frequency (statistical probability of selection and display of the triggering symbol(s), location parameter and bonus, non-bonus parameter, the frequency that the bonus will be triggered can be changed without necessarily changing the frequency at which the trigger associated symbols appear in the display. This provides for having large or small bonuses without changing the trigger symbol selection frequency.

As but an example, where the theme of the game is dogs, the processor may be configured to randomly select a bonus “on” condition 1 out of 5 spins. That is, a data structure may be configured to have five addresses, four representing a non-bonus condition and one representing a bonus condition. The processor may also be configured, for each spin, to randomly select a row, e.g. middle row, in the three row, five column display matrix. Thus if the processor randomly selects an address associated with the bonus “on” condition and a trigger symbol is randomly selected and displayed in the middle row, the bonus would be triggered. In this example, where the bonus “on” condition is selected, the display may be controlled to display a man throwing a bone into the display to be caught by a “dog” trigger symbol in the selected row triggering the bonus. Thereafter the processor may control the display to display bonus award graphics to animate or highlight the award.

### BRIEF DESCRIPTION OF THE DRAWINGS

These and other features and advantages will become appreciated as the same becomes understood with reference to the description claims and drawings wherein:

FIG. 1 illustrates an embodiment of a device according to the present invention including a common display;

FIG. 2 illustrates an alternative embodiment of a device according to the present invention including a separate bonus display;

FIG. 3 illustrates a bonus triggering outcome as well as a concluding display;

FIG. 4 illustrates a first display associated with the bonus feature triggered at FIG. 3; and

FIG. 5 is a logic diagram for the bonus feature.

### DESCRIPTION

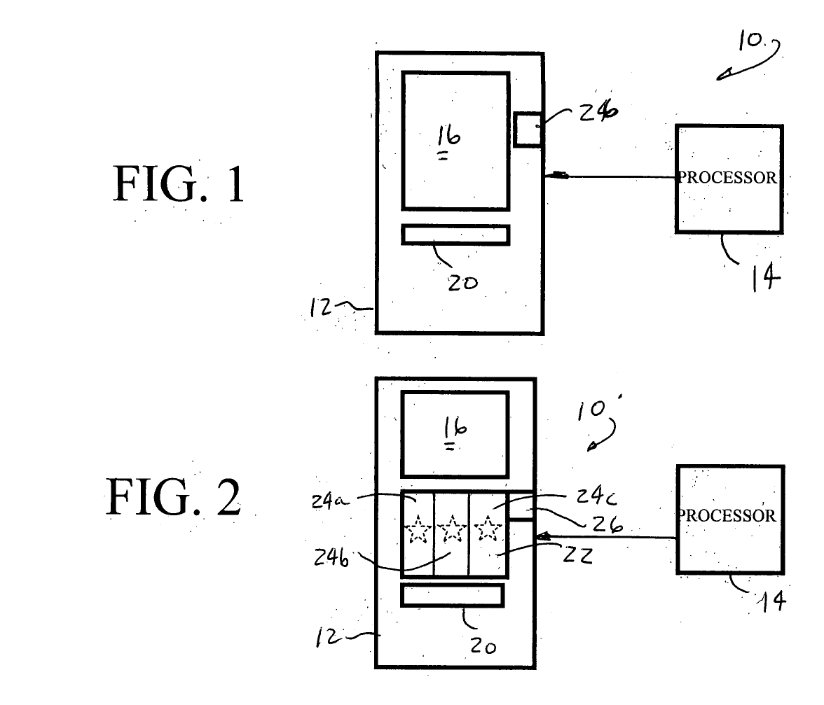

Turning to FIG. 1 there is shown an embodiment of a gaming device 10 according to the present invention. The device 10 is embodied as a gaming machine of the type having a cabinet 12 housing a processor 14 of the type known in the art. Mounted on the cabinet 12 is a display 16 controlled by the processor 14 and which is an electronic display such as a plasma display, VRT, monitor or the like as is known in the art. In the embodiment of FIG. 1 the display 16 is controlled to display the features of a base game and a bonus game according to the present invention.

Not shown in FIG. 1 are wagering means, as is known in the art, such as one or more of a token/coin acceptor, cash validator and acceptor, credit/debit card reader or other suitable means for a player to make wagers to play the game.

While the following description is directed to a casino gaming apparatus where monetary units or their equivalent, such as accumulated gaming credits, are wagered and won, it should be understood that the method can be practiced as a novelty game where fictitious gaming credits are wagered and won such as a computer game, PDA game or other novelty game format.

The controlling computer processor 14 includes a random number generator (RNG) (not shown) and digital data storage device shown as a data structure 18 (FIG. 5). In an alternative embodiment the display 16 may be operated by and communicate with a remotely located processor 14, such as at a remote server. Preferably, the display 16 is embodied as a touch screen display which also provides means for the player to control the play of the game. Alternatively, the play control means may be any suitable data input means such as game control buttons 20 (shown as a group), keyboard, mouse or the like. For purposes of the following description, these data input means will be referred to as a touch screen display 16.

The device 10 also includes a pay out apparatus (not shown) which may be embodied, as is known in the art, as a hopper device to receive coins/tokens and dispense the same, means for accumulating game play credits, apparatus for writing to a credit voucher, credit card crediting device or the like.

As is known in the art, the device 10 may also include a card reader 26 to read a player's loyalty card and identify the player to a player tracking system processor (not shown).

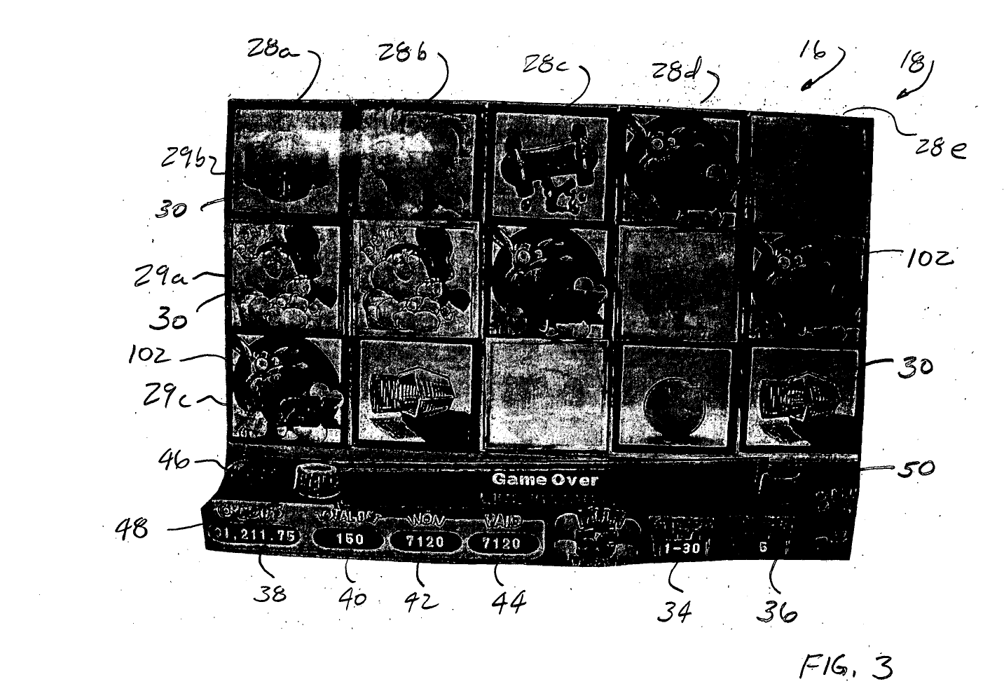

With reference to FIG. 2 there is shown an alternative embodiment of the device 10′. According to this embodiment, the device 10′ has a base game display 22 and a bonus game display 16. The base game-display 22 may be an electronic display or may be a location to view three electromechanical reels 24a-c which display outcomes for the base game in a manner as hereinafter described.

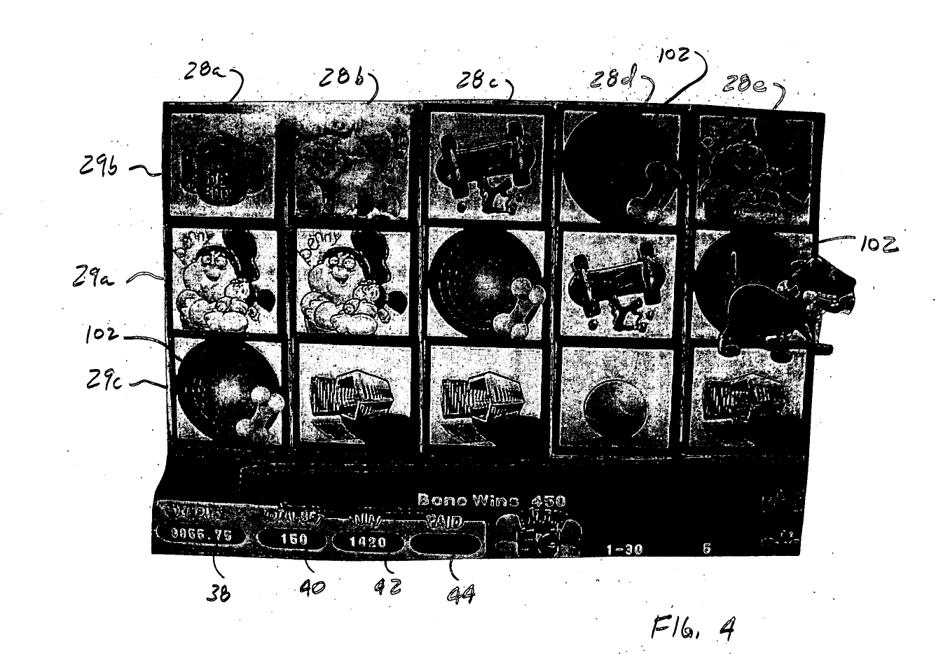

With reference to FIGS. 3-5, the base game is a video slot machine game of a species which is known generally in the art. The processor 14 controls the display 16 (for the FIG. 1 embodiment) to display outcomes represented by the spinning of five reels 28a-e and where each reel 28a-e displays three game symbols 30 defining, for the base game display, three rows 29a-c of a three row, five column (3×5) matrix.

FIG. 3 also shows the touch screen display 16 for the device 10. To play the game, the player makes a wager to enable from one or more pay lines, e.g. 5-15 as is known in the art. Flags or makers (not shown) indicate to the player which pay lines have been enabled by the wager. At the bottom of the display 16 there are also shown certain features relative to the play of the game. At 34 there is a display showing the number of pay lines enabled and at 36 there is displayed the amount of the bet per pay line. Credit meter 38 shows the number of credits (or cash equivalent) available for wagering. At 40 there is shown the total bet for a spin or “hand” of the game. Win meter 42 displays the amount the player has won on a spin of the game and paid meter 44 shows the amount the player has won on that spin.

Other touch screen buttons may also be provided as is familiar to those skilled in the art. Cash out button 46, is touched by the player, prompts the device 10 to issue the amount of the credit meter 38 to the player, help button 48 prompts the processor 14 to control the display 16 to display information concerning the certain features of the game for the player and pay table button 50 prompts the processor 14 to display the pay table for the game.

To play the game the player makes a wager to enable one or more of the play lines for the game. The player then prompts play of a spin by touching an appropriate button 20 (play may be prompted by a wager to enable all pay lines with a maximum wager, e.g. 5 credits for each of five pay lines). The processor 14 is configured to, at 100 (FIG. 5) randomly select and display symbols 30 on the display in the manner suggested by FIG. 3. As can be appreciated from FIG. 3, the arrangement of five reels 28a-e with three symbols 30 per each reel defines the game display, 3×5 matrix defining fifteen matrix cells, each occupied by game symbols 30. Based upon the combinations of symbols 30 selected and displayed on enabled pay lines or scattered through out the matrix, the payer obtains one of a winning or losing, base game, outcome. If the player obtains a winning combination of symbols 30 on an enabled pay line (or scattered within the display), the player receives an award.

In FIG. 3 there is also shown examples of bonus trigger symbols 102 shown as an animation of the face of a dog. While the trigger symbols 102 in FIG. 3 show a multiplier associated with each, it should be understood that unless the bonus is triggered as hereinafter described, multipliers would not be displayed or revealed. The processor 14 and symbol data structure 18 are configured for the random selection and placement of all symbols 30, 102 in the display matrix. The statistical probability for selection and display, as is known in the art, can be controlled by the frequency at which the symbol data is distributed in the symbol data structure 18. It may be desired that certain symbols are selected and displayed more frequently than others and hence those symbols would enjoy a greater distribution in the data structure 18 than would symbols whose selection are less frequent. Related to the symbol distribution is the statistical probability of any symbol combination outcome occurring. Thus, and as is known in the art, by constructing the frequency distribution of symbol data in the data structure 18, the hit frequency of any outcome can be determined as, well. By assigning an award to selected outcomes and knowing their hit frequency, the performance of the game can be designed and determined.

It should be appreciated that the trigger symbols 102 may be like symbols or different symbols-as desired, such as a family of symbols.

With reference to FIGS. 3-5 the bonus according to the present invention will be described. The selection and display of trigger symbols 102 does not, in and of itself, trigger the bonus phase of the game. At least one other, off screen, parameter must be selected to qualify the player to the bonus. As shown in FIG. 5, at 100 the processor 14 randomly selects the base game outcome which may or may not include the bonus trigger symbols 102. The processor 14, with its RNG randomly selects and displays for each reel 28a-e data corresponding to base game symbols 30, 102 an assigns each selected symbol to a position in the matrix.

In conjunction with the selection and display of symbols 30, 102, the processor at 104 selects whether to turn the bonus feature “on” or “off”. For example, the processor 14 may be configured to randomly select from five numbers, e.g. 1-5, with the numbers 1-2 and 4-5 having associated therewith a bonus off condition and number 3 having a bonus on condition. Thus the selection of a bonus on condition has a probability of occurring of 1:5. The probability can be altered to provide a greater or lesser likelihood of the processor 14 selecting the bonus “on” condition.

Also in conjunction with the selection and display of the base game symbols 30, 102, the processor 14 is also configured to select at 106 a matrix location parameter such as by randomly selecting at least one of a matrix row (e.g. row 29a), column of matrix cell. By configuring the processor 14 to select a row 29a-c provides a 1:3 chance that any particular row will be selected. Using the column parameter provides a 1:5 chance and using a cell provides up to a 1:15 chance depending upon the number of columns, rows or matrix cells selected. The present description shall be based upon the random selection of a row 29a-c, specifically row 29a.

At 108 the processor 14 is configured to test the selected symbols to determine if any trigger symbols 102 have been selected and displayed. If no trigger symbols have been selected, there is no bonus for the spin. If one or more trigger symbols 102 have been selected, at 110 the processor 14 compares the locations of the trigger symbols 102 in the matrix to determine if any such locations correspond to the location parameter selected at 106. If there are no bonus trigger symbol 102 locations in the matrix which correspond to the selected location parameter, there is no bonus. With reference to FIG. 3 there is a bonus trigger symbol 102 located in the selected row 29a (at reel 28e), thus the player may still be eligible for the bonus.

At 112 the processor 14 determines whether the bonus “on” parameter has been selected. If the bonus “on” condition was not selected, there is not bonus. If at 112 the bonus “on” condition was selected at 114 a bonus s awarded.

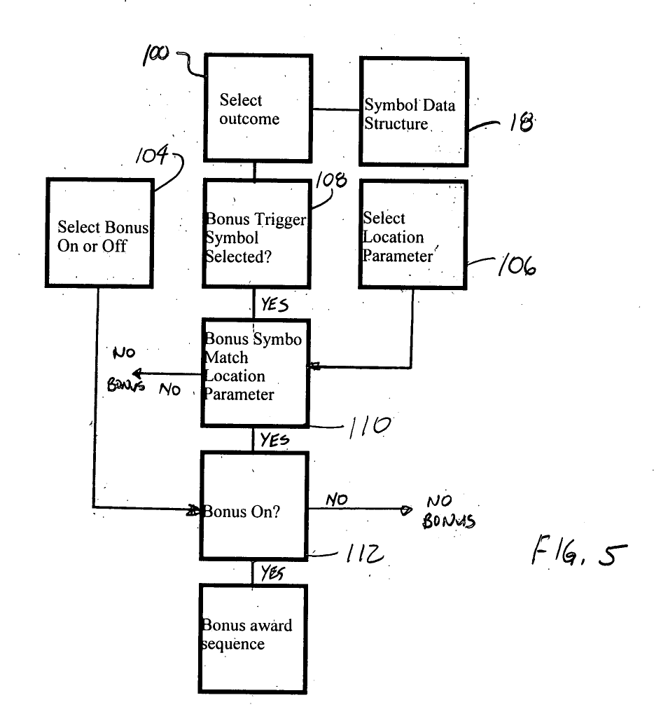

When at 114 a bonus is awarded, the processor 14 may be configured to control the display 16 to display graphics to highlight the bonus. As but an example, if a bonus “on” condition is selected, the processor 14 may control the display to show a ball being thrown into the matrix display. If a bonus trigger symbol 102 has been selected and displayed in the selected location, e.g. row 29a, the trigger symbol 102 “dog” is displayed to catch the bone and proceed with a bonus award sequence. This sequence may include a dog going to each trigger symbol 102 in the display and shown digging up a bone to reveal a multiplier as is suggested in FIG. 4 which represents an award of the total amount bet X the multiplier. Other forms of awards may be issued as well.

Still further, other symbols may interact in the bonus. With reference to FIG. 4, if a “cat” symbol has been selected in the matrix, the processor 14 may control the display 16 to show a dog fighting with the cat and double the awards as well.

The present invention may include using one or both the ff screen selection parameters of location and/or the bonus on condition. For example, the onus may always be “on” requiring only the selection of the bonus trigger symbol 102 into the selected location, e.g. selected row 29a-c. Also, the location may be fixed, e.g. row 29a with the bonus being triggered in connection with the selection of the trigger symbol 102 and the selection of a bonus “on” or bonus “off” condition.

By adjusting the desired frequency of selection of the bonus “on” condition as well as the selection of the location parameter, the frequency at which the bonus is triggered can be altered without disturbing the frequency distribution of the trigger symbol(s) in the data structure. Further, the contribution from the bonus feature to the overall performance of the game can be adjusted in this manner to provide for frequent display of the trigger symbols while limiting the frequency at which the bonus is actually triggered. Still further, the present invention provides an opportunity to display elements moving into the matrix, e.g. a ball being cast into the matrix to designate and display the bonus “on” or “off” condition.

While we have shown and described certain embodiments of the present invention it should be understood that it is subject to many modifications and changes without departing from the spirit and scope of the appended claims.

1. A gaming device comprising:
a game display to display a plurality of reels, each reel including a plurality of symbols movable with movement of the reels during play of the game to produce an outcome, said display displaying said outcome in matrix-form;
a bonus trigger associated with at least one of said symbols;
a processor configured to select a matrix location parameter and to issue a bonus upon the concurrence of (i) an outcome including a bonus trigger and (ii) a bonus trigger associated symbol is positioned is association with the selected matrix location parameter.

2. The device of claim 1 comprising said processor configured to select said location parameter from a group consisting of (a) a coordinate of the matrix, (b) a row of the matrix and (c) a column of the matrix.

3. The device of claim 1 comprising said processor configured to (iii) randomly select between a bonus and non-bonus condition and to issue a bonus award upon the concurrence of (i), (ii) and (iii).

4. The device of claim 1 comprising said processor configured to control the display to display a bonus award sequence in awarding said bonus.

5. The device of claim 1 comprising preselecting at least one symbol as a bonus trigger symbol and said processor configured to issue an award relative to the number of bonus trigger symbols in said outcome.

6. The device of claim 5 comprising said processor configured to control the display to display a bonus award sequence in an action sequence including said trigger symbols.

7. A gaming device comprising:
a game display to display a plurality of reels, each reel including a plurality of symbols movable with movement of the reels during play of the game to produce an outcome, said display displaying said outcome in matrix-form;
a bonus trigger associated with at least one of said symbols;
a processor configured to select a matrix location parameter and between a bonus and non-bonus condition and to issue a bonus upon the concurrence of (i) an outcome including a bonus trigger, (ii) a bonus trigger associated symbol is positioned is association with the selected matrix location parameter and (iii) selection of a bonus condition.

8. The device of claim 7 comprising said processor configured to select said location parameter from a group consisting of (a) a coordinate of the matrix, (b) a row of the matrix and (c) a column of the matrix.

9. The device of claim 7 comprising said processor configured to control the display to display a bonus award sequence in awarding said bonus.

10. The device of claim 7 comprising said processor configured to control the display to display a graphic sequence to indicate the selection of at least one of a bonus or non-bonus condition.

11. The device of claim 7 comprising designing at least one symbol as a bonus enhancement symbol and said processor configured to determine the selection and display of said bonus enhancement symbol and to increase said bonus award.

12. A gaming device comprising:
a display;
a data structure storing data corresponding to game symbols, at least one symbol designated as a bonus trigger symbol;
a processor configured to (i) randomly select and display game symbols in a matrix form at the display to define at least one base game outcome, (ii) randomly select at least one of a matrix location parameter and bonus on-off parameter, (iii) detect the selection and display of a bonus trigger symbol and its correspondence to said at least one parameter to trigger a bonus award and (iv) if a bonus award has been triggered, issue a bonus award to the player.

13. The device of claim 12 comprising said processor configured to randomly select a matrix location parameter from a group consisting of at least one of a row, column or a matrix coordinate.

14. The device of claim 13 comprising said processor configured to select and apply both of said selected location parameter and said bonus on-off parameter in detecting if a bonus has been triggered.

16. A method for playing an electronic gaming device comprising:
providing a game display to display a plurality of reels, each reel including a plurality of symbols movable with movement of the reels during play of the game to produce an outcome, said display displaying said outcome in matrix-form;
associating a bonus trigger with at least one of said symbols;
configuring a processor for selecting a matrix location parameter and issuing a bonus upon the concurrence of detecting (i) an outcome including a bonus trigger and (ii) a bonus trigger associated symbol is positioned is association with the selected matrix location parameter.

17. The method of claim 16 comprising (iii) randomly selecting between a bonus on and a bonus off condition and issuing a bonus award upon the concurrence of (i)-(iii).
